(19) United States
(12) Patent Application Publication
(10) Pub. No.: US 2018/0129480 A1
(43) Pub. Date: May 10, 2018

(54) USER RESEARCH LED SOFTWARE DESIGN AND DEVELOPMENT PROCESS

(71) Applicant: SAP SE, Walldorf (DE)

(72) Inventors: Panagiotis Constantinos GERMANAKOS, Wiesloch (DE); Alexandra Johanna MATZ, Schwetzingen (DE)

(21) Appl. No.: 15/347,814

(22) Filed: Nov. 10, 2016

(51) Int. Cl. G06F 9/44

(52) U.S. Cl. CPC G06F 8/20

(57) ABSTRACT

A user research-led design framework for a software design and development process is provided. In accordance with one aspect, research materials are received from a user in a user research stage of the software design and development process. User input including attributes of a use case to be created is further received. The attributes of the use case is dynamically analyzed as the user input is received. Validation messages are displayed on the user interface based on the analysis. The use case is created and stored in a database. The created use case is visualized using a hybrid use case diagram comprising diagrammatic and textual representations of the attributes of the use case. A readiness check may be performed based on the received research materials to determine the readiness status of the user in the software design and development process.

### TECHNICAL FIELD

The present disclosure relates generally to computer systems, and more particularly, a framework for a software design and development process.

### BACKGROUND

Developing software in a large scale such as collaborating with hundreds, even thousands, of people and teams that have divergent product scopes and multi-purpose use cases, make it improbable to (i) target and satisfy all ends within the given time constraints (i.e. delivery cycles); (ii) maintain a viable transparency and alignment among them; and (iii) ensure the necessary quality according to standards dictated by design and development guidelines and principles. This results to solutions or final products that many times are not based on real end-user requirements and inevitably creates frustration since teams fail to satisfy the expectations once they enter the design or development stage.

Additionally, most teams miss to define use cases correctly (if not omit them) given the tight time delivery schedules. The criticality of use cases lies in the fact that it serves as the connecting point of research with design. Use cases should be readable and understandable by all project stakeholders, sponsors and the end-users. It is the step that more abstract and fuzzy descriptions of the activities and tasks are transformed into more tangible interactions between the involved entities (such as user roles and system). In many cases, the same use cases (often belonging to different user roles) are re-defined driven by the different scope and viewpoints of various project teams, and leading to redundancies and/or incomparable results.

### SUMMARY

A user research-led design framework for a software design and development process is provided. In accordance with one aspect, research materials are received from a user in a user research stage of the software design and development process. User input including attributes of a use case to be created is further received. The attributes of the use case is dynamically analyzed as the user input is received. Validation messages are displayed on the user interface based on the analysis. The use case is created and stored in a database. A readiness check is performed based on the received research materials to determine if the user is ready to enter a design stage of the software design and development process.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures. Like reference numerals in the figures designate like parts.

FIG. 1a shows an exemplary environment;

FIG. 1b illustrates an exemplary product definition process of a framework;

FIG. 2 shows an exemplary architecture of an embodiment of a use case development application;

FIG. 3 shows an exemplary use case database model in a database module;

FIG. 4 illustrates an exemplary UI of a wizard-based use case creation guidance;

FIGS. 5a-5b illustrate another exemplary UI of the wizard-based use case creation guidance;

FIG. 6 shows an exemplary sequence diagram of a similarity analysis performed by a use case and persona analyzer unit;

FIG. 7 illustrates an exemplary hybrid use case diagram which is used to visualize a use case;

FIG. 8 shows an exemplary UI displaying a list of use cases and a use case diagram of a particular created use case; and

FIG. 9 illustrates an exemplary class diagram of the use case development application which interfaces with the collaboration platform.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of present frameworks and methods, and to thereby better explain the present frameworks and methods. Furthermore, for ease of understanding, certain method steps are delineated as separate steps; however, these separately delineated steps should not be construed as necessarily order dependent or being separate in their performance.

A framework for software design and development using an intelligent system and one or more applications is described herein. In one implementation, the framework provides design service tools to facilitate users (e.g., a plurality of teams) in the software design and development process. The framework may be independently accessed by different project teams in parallel to build one product together, different parts of the same product or different products. The framework includes a user research phase or stage which incorporates user research materials by the teams prior to starting the design and development process. In one implementation, a readiness check function is provided to ensure that project teams' research activity steps and deliverables are incorporated with distinct visibility and clarity before starting the design and development phase. The framework advantageously ensures teams have a thorough understanding of end-users needs, requirements and pain-points before entering the design stage, thus allowing consistency and quality in an end-to-end design and development process.

In one implementation, the framework includes an application for creating and documenting use cases, with the creation of use cases being a major part of the framework. Use cases generally describe scenarios or list of action steps and interactions among entities such as a user and a system to achieve a desired goal or function. The framework, in one implementation, provides guidance such as a step-by-step guidance that facilitates definition of use cases by users. The guidance provided by the framework may be a What You See Is What you Get (WYSIWYG) guidance. In one implementation, the framework dynamically performs validation of the use case definition as user input is received. The validation includes semantic and syntactic validation of text strings in the user input. The validation of the use case definition is performed based on use case rules as well as semantic and syntactic algorithms stored in a database or repository.

In some implementations, the framework performs use case and persona analysis based on the use case definition in the user input. The use case and persona analysis is performed against existing use case and persona information stored in the repository to determine similarity of the user input with information of the existing use cases and personas. The framework generates a recommendation containing one or more use cases in the repository with similarity to the user input and presents the recommendation to the user. The framework may generate a use case and persona analysis report based on the analysis, and store the report in the database. In some implementations, the framework evaluates the quality of the created use cases. Determining the quality of the created use cases facilitates the design and development process.

In accordance with one aspect, the framework employs a hybrid use case diagram to visualize a use case. The hybrid documentation includes diagrammatic and textual representations of the use case. In one implementation, the hybrid use case diagram includes a distinction between entities of the use case. For example, the hybrid use case diagram includes a distinction between the entities in the use case such as the user and the system. The hybrid use case diagram visualizes an interaction flow of activities between the entities. The hybrid use case diagram, for example, includes interaction lines indicating the flow of information between the entities. The hybrid use case diagram may serve as evaluation points of a single interaction (e.g., accuracy, efficiency, effectiveness).

In accordance with another aspect, the use case definition may be posted in a collaboration network or platform, facilitating a collaborative creation of use cases. For example, the use case definition is made available in a discussion forum or in a collaboration-and-feedback site to obtain feedback regarding the created use case (e.g., proposed changes in the use case definition). The framework advantageously facilitates consistent definition of use cases in a collaborative environment which improves quality and precision of the use cases. Such use case definition process serves as a basis of interaction design of use cases which allows for more qualitative system designs to the benefit of end users.

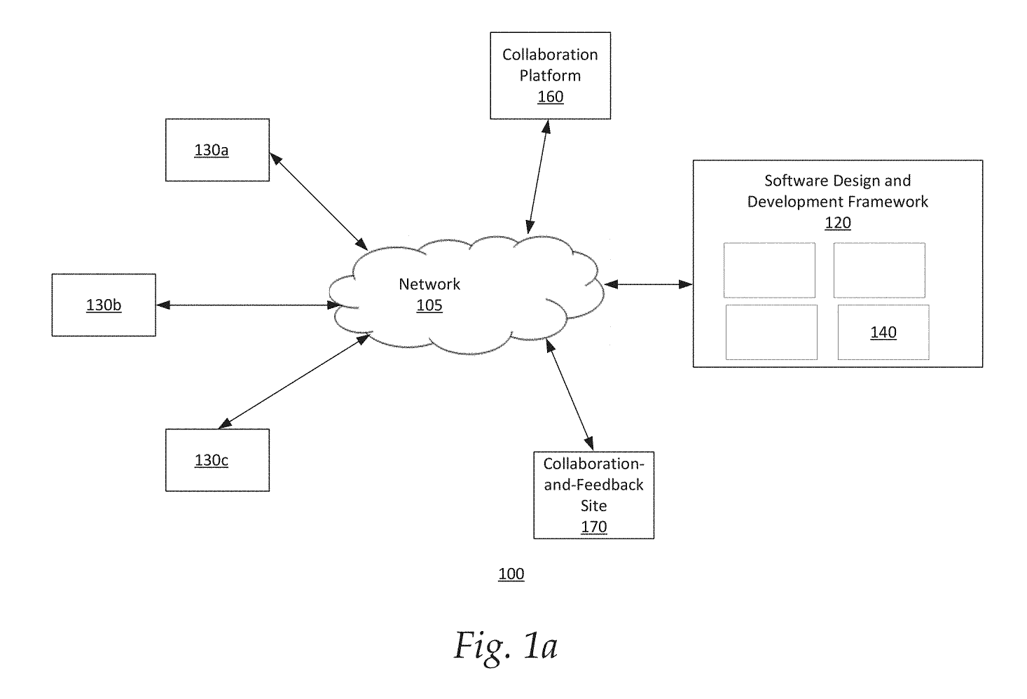

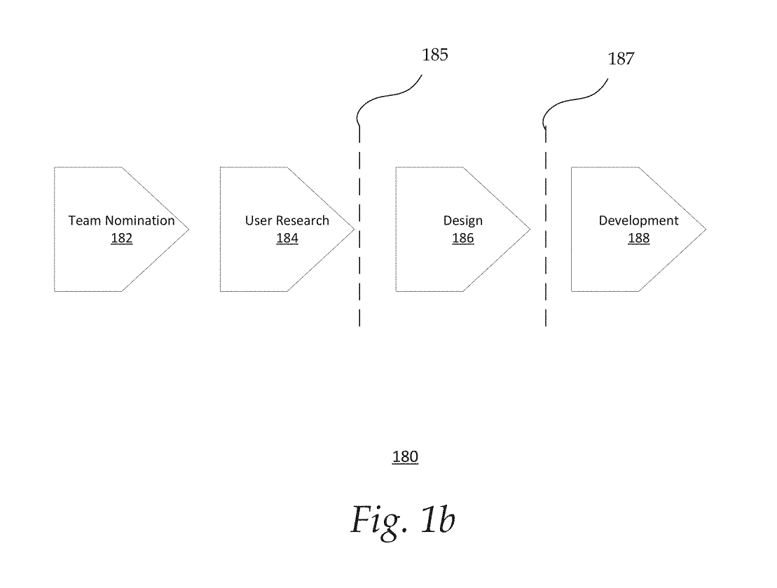

FIG. 1a shows an exemplary environment 100. The environment, for example, facilitates the user research-led software design and development process. In one embodiment, the environment includes a communication network 105. The communication network may be, for example, the internet. Other types of communication networks or combination of networks may also useful. The environment includes a plurality of servers and clients or devices 130a-c coupled to the communication network.

A server may include one or more computers. A computer includes a memory and a processor. Various types of computers may be employed for the server. For example, the computer may be a mainframe, a workstation as well as other types of processing devices. The memory of a computer may include any memory or database module. The memory may be volatile or non-volatile types of non-transitory computer-readable media such as magnetic media, optical media, random access memory (RAM), read-only memory (ROM), removable media, or any other suitable local or remote memory component.

In the case where the server includes more than one computer, they are connected through the communication network such as an internet, intranet, local area network (LAN), wide area network (WAN), internet or a combination thereof. The servers, for example, may be part of the same private network. The servers may be located in single or multiple locations. Other configurations of servers may also be useful. For example, the servers may form a cloud.

As for the client or user devices, they may be any computing devices. A computing device, for example, includes a local memory and a processor. The computing device may further include a display. The display may serve as an input and output component of the user device. The memory may be volatile or non-volatile types of non-transitory computer-readable media such as magnetic media, optical media, RAM, ROM, removable media, or any other suitable memory component. Various types of processing devices may serve as user devices. For example, the user devices may include a personal computer, or a mobile client device such as a smart phone. Other types of user devices, such as laptops or tablets may also be useful.

A user may connect to a server using a user device. The user device may be referred to as the client side while the server may be referred to as the server side. A user may access the server by logging in the user's respective account with, for example, a password using a user device. A user may communicate with the server via a user interface (UI) on the user device. The UI may be a web-based UI. For example, the UI is displayed on the user device when a web page of a use case development application on a server as described below is accessed by the user. Other techniques for communicating with the server may also be useful. Alternatively, the UI may be an application-based UI.

In one embodiment, the environment includes a software design and development framework 120. The framework, in one embodiment, is a user research-led software design and development framework. The software design and development framework, for example, resides on a server. Alternatively, the software design and development framework may reside on a plurality of servers. For example, the server or plurality of servers is residing in the cloud. A software design and development process is implemented by the framework. The software design and development process, in one implementation, is a User Experience (UX) User Research-Led Design (UR-Led Design) End-to-End (E2E) Product as a Service (PaaS) Definition Process, or also referred as User Research-Led Design (UR-Led Design) framework by SAP SE. The software design and development process includes research methods, design service tools and/or one or more applications for facilitating a consistent and quality design and development process. The research methods, service tools and/or applications provide teams with solutions and support as and when needed during the design and development process. For example, teams may access the framework and use the service tools to request and obtain support if it is available. The research methods, service tools and/or applications may be employed, for example, as needed by teams before the readiness check function is implemented. In some cases, the readiness check function may be implemented as a mandatory step in the software design and development process.

In one implementation, the service tools facilitate teams in developing user-research materials and artifacts and receive the user-research materials and artifacts from the teams. The research materials may be collected by teams, for example, from interviews, field studies, observations with the end-users during the requirements collection phase. The research materials may include, inter alia, interviews, personas, activity flows, use cases, user story maps, task analysis, storyboards. The research materials, for example, determine the content and guide the information flow and action steps of a use case to be developed later. Once the research materials are sufficiently documented, a team can proceed to the creation of use cases which will in turn serve as a basis, in the next step, for the interaction and visual design of a user interface, before the actual system integration and development starts.

The service tools, in one implementation, provides (i) ad hoc assistance or quality control of current user research deliverables which is implemented as an ad-hoc consultation service, (ii) full training session with respect to specific user research tools and activities which is implemented as a skill-up service (for example, using class-room teachers or digital learning services), and (iii) assignment of a dedicated user researcher to product teams to support them throughout the product definition process, which is implemented as a request project support service. An example scenario is where a team registers to the framework and is assigned with a user researcher or interaction designer from the beginning of the definition process. The user researcher may support them throughout the definition process. A team may have executed user research in the past but not have all the user research deliverables available or up-to-date. In such case, the material in place will be evaluated and if they are found to be on the expected quality the team can make use of the other services in the framework. For example, the team may utilize activity flows or use cases that will help them to prepare according to predefined standards.

Additionally, if a team has all the expected user research deliverables in place, they may apply for the readiness check to be scheduled as an in-person meeting or directly ask for an official pre-evaluation with a possible offline sign-off by user research experts evaluating the material through the employment of digital services. A team may request tips or advices regarding specific issues and progress having assigned a user researcher. In the case where a team is not ready for the readiness check of their research materials, they may use a set of user research educational sessions available in the framework and apply for the product definition process and the readiness check later. The quality of the user research material is directly related to a consistent approach, the customer visits and the number of end-users a team has observed and/or interviewed as well as to the depth and the extent of the analysis with respect to the collected requirements. The framework allows the ability to dynamically assign, reassign, associate, etc., any number of internal and/or external resources (individuals, teams, etc.) at any process step or point in time. For example, for a given activity or event, the framework allows teams to dynamically define inter alia attributes such as name, duration, predecessor(s), predecessor constraints, requirements, resources, tasks, successor(s), successor constraints.

The framework advantageously provides flexibility, scalability and extensibility through dynamically configurable paths to unlimited number of teams working in parallel while the same time researching and focusing on real end-users' needs. Also, the framework provides action steps and deliverables as standalone services of different forms that teams can utilize depending on their projects' needs and requirements ensuring high levels of their development process optimization, transparency, with less costs and resources utilization. The framework facilitates a flexible end-to-end process that enhances the synergy among various users in the software design and development process and improves clarity and understanding of their projects, alignment with their project rules, accuracy in prioritization and planning, estimation of a system's complexity and cost, and allocation of time and budget.

The research readiness function or check ensures that teams have a thorough understanding of their end-users needs, requirements and pain-points and enter the design phase with the adequate quality. This increases speed of the design and development and minimize costs and resources from unnecessary iterations by identifying their research readiness status based on prior work and accordingly provide the best-fit solution and support.

FIG. 1b illustrates an exemplary user experience user research-led design (UR-Led Design) end-to-end product as a service (PaaS) definition process (referred herein as product definition process) 180 of the framework. The product definition process includes team nomination, user research, design and development stages 182, 184, 186 and 188. The team nomination stage includes initial assignment of teams that will participate in a research and design life-cycle that takes place based on a strategic product portfolio. The nominated team should meet all the necessary prerequisites such as clear values for the planned product or application covering end-user needs, have all resources available for the next stage (e.g., user experience advocates that scale the User Experience knowledge in an enterprise through training, for example, programmers within a product development organization on user experience basics so they can be a first level instance of support in their groups).

The user research stage runs in a decentralized mode where product teams run research with support. For example, product teams run research with the support of user experience (UX) experts. In this stage, user researchers and/or user experience designers may be assigned to the product teams. Synchronization of the user research may be performed iteratively between the teams with the user researchers and/or user experience designers, therefore enabling efficiency and quality of content in the user research material. Additionally in the user research stage, through regular synchronization of the user research, common or conflicting roles may be identified early by the user researchers and/or user experience designers. Additionally, all materials to be used may be available from a central access point in the framework.

The user research stage includes the following activities and deliverables for the product teams, for example, over a particular timeline. Knowledge consolidation and end-user recruitment activity which includes a 360 degree knowledge consolidation (including market potential, white spot analysis, process gaps, end-users knowledge), preparation of interview guides (e.g., collection of questions). The deliverables of the activity include an accumulated knowledge white paper, the list of end users (names anonymized for data security purposes) and their roles in their organization, a list of interview questions. Field research activity where teams conduct interviews and observations are based on prepared interview guides. The deliverables of the activity include interview notes and artifacts. Research synthesis activity then takes place, which includes consolidation of interviews and observations materials. The deliverables of the activity include user needs, roles, pain-points, business processes and task-flows.

Personas and tasks activity which includes reframing and redefining the product's scope and objectives based on end-users feedback, and personas creation and tasks prioritization. Presentations may be performed by all teams for alignment and conflicts resolution on personas and tasks. The activity enables the synchronization of the product definition process as teams present their user research material, for example, to user researchers and user experience designers. The identification of common roles and conflicting tasks takes place in this stage, including identification in more detail of common features, resolving (where possible) overlaps between use cases in different roles, building, for example, industry-specific extensions to overlapping use cases when needed, networking between product owners, and trying to increase the quality of use cases to be used in the next stage of design. In some implementations, the presentations may be performed remotely by the teams. The deliverables of the activity include product definition, key benefits and capabilities, personas, task relevance frequency diagram.

Use cases and storyboards activity which includes use cases and storyboards creation. The deliverables of the activity include use cases diagrams and storyboards. Finally, validation and readiness check activity which includes user validation of research material and iteration as well as preparation for the readiness check is performed in the user research stage. The deliverables of the activity include a readiness check template.

After the user research stage, the readiness check function is implemented at 185. The readiness check function, for example, serves as a user research gate to filter teams that can qualify for the next stage. This ensures that the product teams are well prepared for the design stage. Personas and use cases will be evaluated, for example, by a dedicated committee of User Experience experts and managers with respect to the degree of alignment and quality. Decision on teams that can qualify for the next design stage is made depending on whether the teams comply with the research criteria set. Teams that qualify must have a clear view of the research undertaken, and all the knowledge, results and lessons learned will serve as the basis to formulate the stage of the design and development process. Teams that do not qualify will be transferred to the next development cycle, therefore affording them time to improve their end-user knowledge by performing further research.

As for the design stage, only teams that have qualified from the readiness check will participate and conduct further design activities. As for the development stage, an evaluation is first performed at 187 to determine whether product designs are aligned with a particular set of design principles and conform to a set of design guidelines and thus can qualify for the development stage. Product teams may iterate and refine their designs prior to the development stage (e.g., including end-user feedback from usability tests).

Returning to FIG. 1a, in one embodiment, the software design and development framework includes a use case development application 140 that facilitates use case definition and documentation. The use case development application may be an interactive system for creating and documenting use cases consistently and collaboratively. The material and information used by the use case development application includes the analysis and outcomes from the end-user research conducted earlier in the product definition process during the user research stage. For example, the deliverables which include the personas, user story maps, activity flows, task analysis, storyboards, determine the content and guide the information flow and action steps of a use case. The created use case may be part of the user research material. The created use case may then be a basis in the next step, for example, for the interaction and visual design of a user interface, before the actual system integration and development starts. Developing a more precise and inclusive use case allows for a higher probability to develop more qualitative system designs to the benefit of the end-users.

In some embodiments, the use case development application communicates with a collaboration platform 160 and collaboration-and-feedback site 170. The collaboration platform, in one implementation, includes a use case and persona collaboration and discussion forum that allows users, such as project teams, to publish or share their use cases and personas for discussing questions and issues related to the published use cases and personas. Additionally, the collaboration platform may include an open source use case rule framework, where use case rules and algorithms can be shared, extended and modified. For example, the use case rules and algorithms may be modified by other users such as user researchers and user experience designers. Such modified use case rules and algorithms may be downloaded from the collaboration platform to the use case development application.

As for the collaboration-and-feedback site, in one implementation, it may be a platform for receiving feedback of the developed products. In one implementation, feedback regarding the use cases developed in the use case development application may be obtained from the collaboration-and-feedback site. For example, the use cases and personas in a database are uploaded to the collaboration-and-feedback site to run usability validation tests with other users. The collaboration-and-feedback site may be accessed by other users such as other project teams using the developed use case, end-users or customers, use case and persona testers, and other interested parties of the use case. Such feedback or results may be provided or fed back to the use case development application.

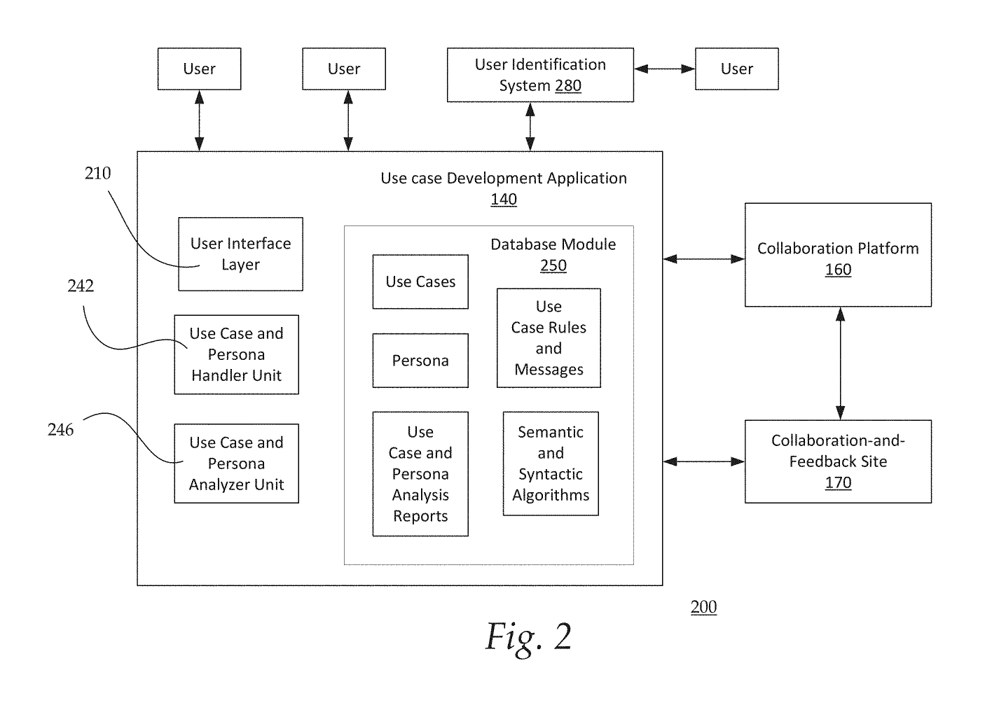

FIG. 2 shows an exemplary architecture 200 of an embodiment of the use case development application. In one embodiment, the use case development application includes a user interface layer 210, a use case and persona handler unit 242, a use case and persona analyzer unit 246 and a database module 250. Providing the use case development application with other components may also be useful. The various components may reside on one or more servers. For example, the components may reside on different servers or on the same server. Other configurations of the components may also be useful.

In one implementation, the database module may be a repository which includes information related to use cases being developed and developed use cases as well as use cases obtained from external sources. The database module, for example, may be a repository containing use cases, personas, use case rules and messages, semantic and syntactic algorithms, and use case and persona analysis reports. The use cases and personas, for example, may be existing use cases and personas which have been developed by various users of the use case development application. In some cases, the existing use cases and personas may be retrieved from external data sources, the collaboration network and collaboration-and-feedback site, and stored in the database module.

In some implementations, the database module contains system intelligence such as the use case rules engine and algorithms. The use case rules engine and algorithms are defined and provided in the database module. The use case rules and messages, and semantic and syntactic algorithms may be used for performing validation and analysis of use cases being developed. As for the use case and persona analysis report, it may be generated by the use case analyzer unit as analysis is performed on use cases being developed. The database module, for example, may be an in-memory database, such as SAP HANA database by SAP SE. Other types of databases may also be useful.

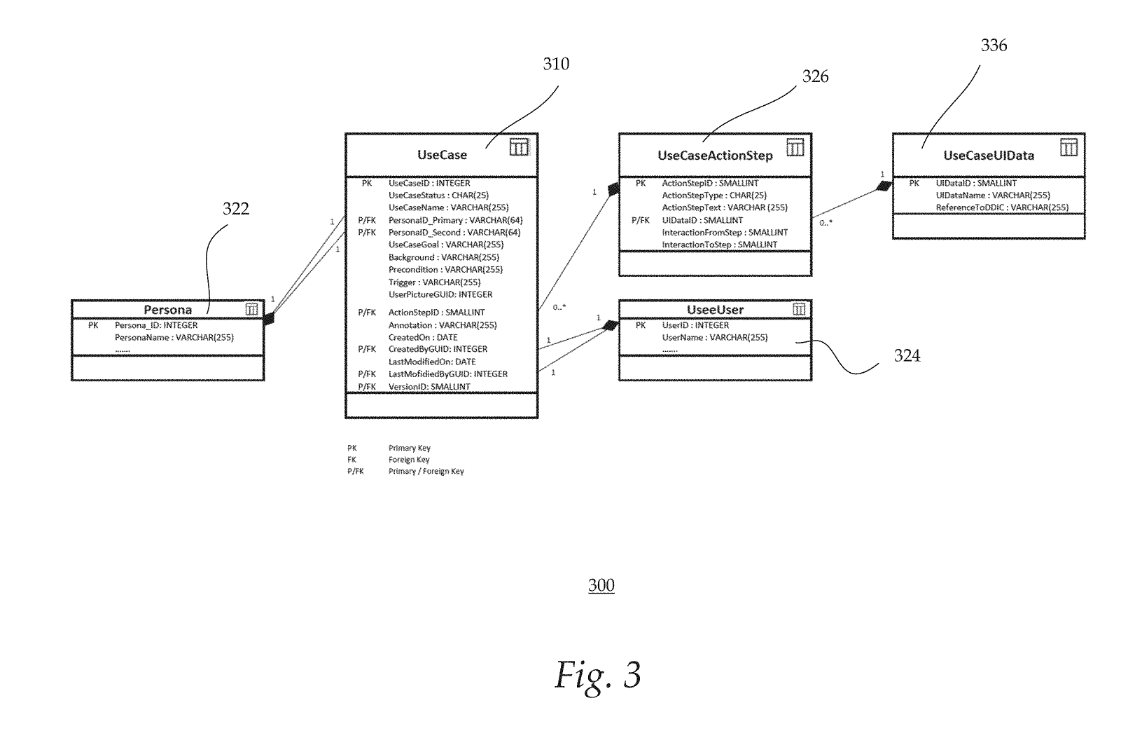

FIG. 3 shows an exemplary use case database model 300 in the database module. A data structure of a use case includes information of the use case. As shown, a use case data structure 310 may include information such as a unique identifier of the use case, status, name, entities or personas, goal, background, precondition, trigger, picture of a particular user defined for the use case, action step, annotation, creation date, creator, date of last modification, identity of last modifier, and version. Providing other attributes or content in the information of a use case may also be useful. In one implementation, the attributes or content of the use case information in the data structure may be categorized. The attributes or content of the use case information, in one implementation, may be categorized by type of integer or character. In some implementations, the attributes or content in the data structure may be categorized based on primary key, foreign key or primary/foreign key. Providing other types of categorization for the use case information in the data structure may also be useful.

In one implementation, the attributes or content in the use case information are further detailed. As shown, information of the persona, use case action step and user is detailed in a persona data structure 322, a user data structure 324 and a use case action step data structure 326. For example, the persona data structure 322 includes identifier of the persona, name of the persona, needs, pain points, job responsibilities. A user data structure 324 includes identifier of the user and name of the user. A use case action step data structure 326 includes identifier of the action step, type, text of the action step, identifier of UI data of the action step, and to and from interactions of the action step. The UI data structure 336 of the action step is further detailed with attributes such as name of the UI data and its reference to the data structure it represents in a data dictionary.

Returning to FIG. 2, a user may interact with the user interface (UI) layer 210 via a client device. In one implementation, the UI layer may be a web-based UI. For example, a user may access the UI using a web browser on the client device. The UI layer enables users to interact with the use case development application to (i) manage use cases such as creating new use cases as well as reviewing and modifying existing use cases, (ii) manage personas, (iii) maintain rules and messages which facilitates the syntactical and semantical validations of use case data, and (iv) research, analyze and compare existing use cases through statistical methods and tools, for example, to determine their level of similarity, complexity, semantic quality.

In one implementation, a user identification system 280 may be provided. The user identification system, for example, authenticates the user using the use case development application (or the software design and development framework). In other implementations, the user identification system determines the authorization level of a user using the application and allows for corresponding usage of the application.

The use case and persona handler unit serves to facilitate creation of use cases and personas as well as maintenance and storage of use case and persona data in the database module. In one implementation, the use case handler provides guidance to a user for creating use cases. The use case and persona handler unit, in one implementation, provides guidance as a user defines a use case including the persona of the use case. For example, a wizard-based use case creation guidance is provided on the UI to obtain user input of a use case definition.

The use case definition, for example, includes attributes of the use case being created. The attributes include, inter alia, entities or personas information such as first or primary user, secondary user, user roles, user needs, goals, pain points, current tasks, pre-conditions, actions steps, description, trigger, interaction data and data sources, alternative ways and possible failures. The wizard-based use case creation guidance is a step-by-step guidance that prompts the user for input of the use case definition. In some implementations, the use case and persona handler unit facilitates a graphical WYSIWYG UI displayed by the UI layer on the client device. Using other techniques for obtaining user input may also be useful.

In one implementation, the use case and persona handler unit dynamically performs validation of the user input as it is provided on the UI by a user. The use case and persona handler unit performs validation of the user input using validation rules and semantic and syntactic algorithms in the database module. For example, the use case and persona handler unit performs the validation on text strings of the user input. The use case and persona handler unit, in one implementation, validates key words of the use case definition provided in the user input with attributes or content of existing use case and persona information stored in the database. A result of the validation is the returned and the use case and persona handler unit displays a validation message on the UI of the client device. The validation message, for example, indicates a successful validation. In the case of an unsuccessful validation, a recommendation of alternative key words may be suggested to the user. In some implementations, the use case and persona handler unit performs validation of the user interaction during the software design and development process. For example, the use case and persona handler unit performs validation of the user interaction in developing a use case to determine efficiency of generating creation of the use case.

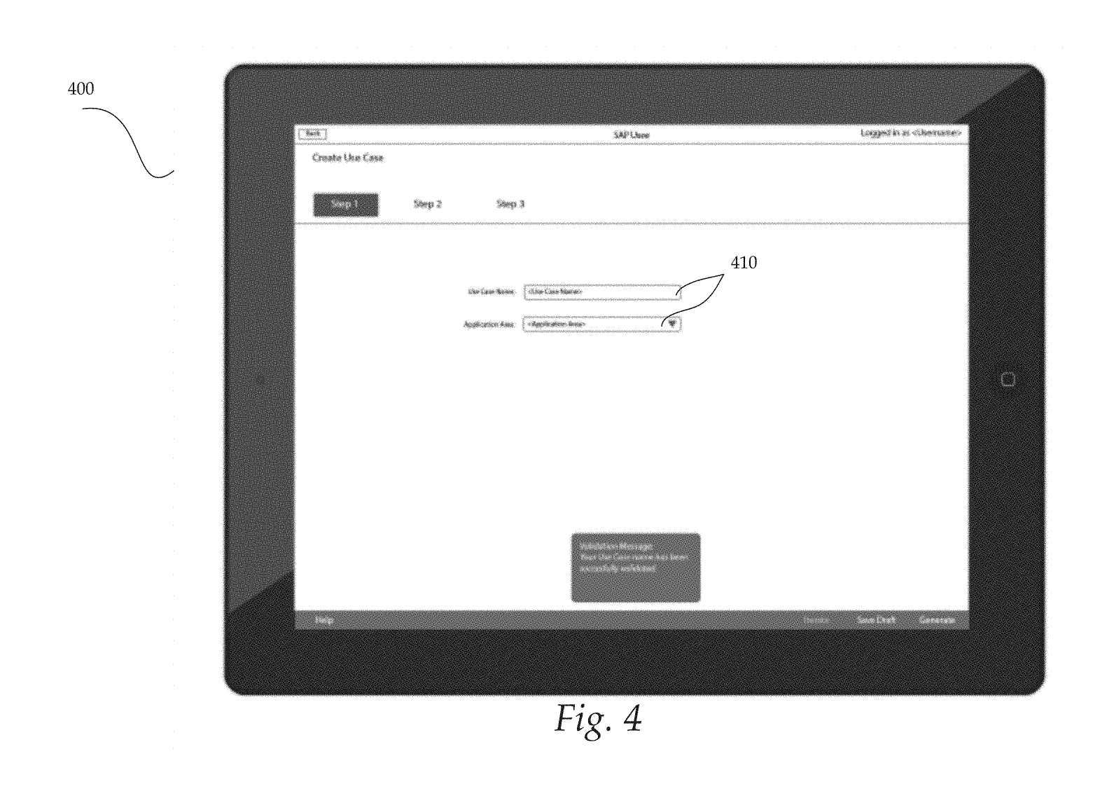

FIG. 4 illustrates an exemplary UI of a wizard-based use case creation guidance. For example, an exemplary UI 400 with the first step of the wizard-based use case creation guidance is shown. As illustrated in FIG. 4, a UI of the wizard-based use case creation guidance displays fields 410 which prompt a user for information of the use case to be created. For example, the user input may be a name of the use case. As the user input is provided, the use case and persona handler unit dynamically performs validation of user input. The user input may be parsed and analyzed using the validation rules. In this case, the use case and persona handler unit determines a semantic validation of the use case name. The use case and persona handler unit performs the semantic validation and returns a validation message that indicates a successful or unsuccessful validation. Such validation advantageously assists users in developing consistent and quality use cases as more accurate use case attributes are input and defined in the system.

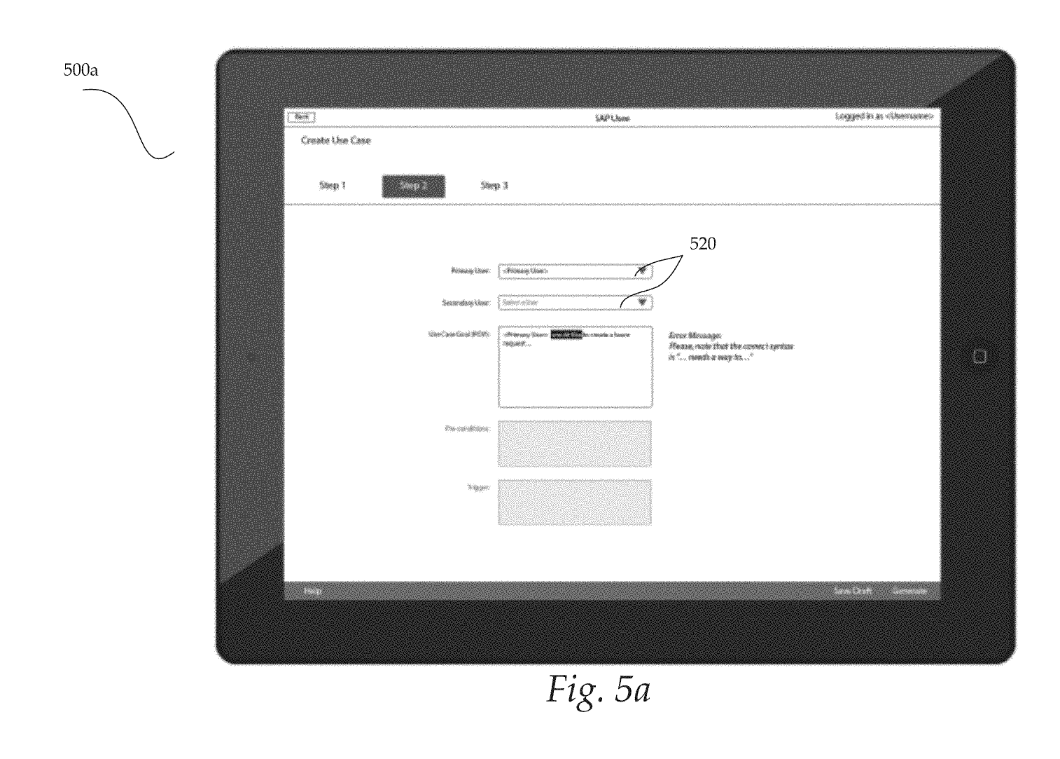

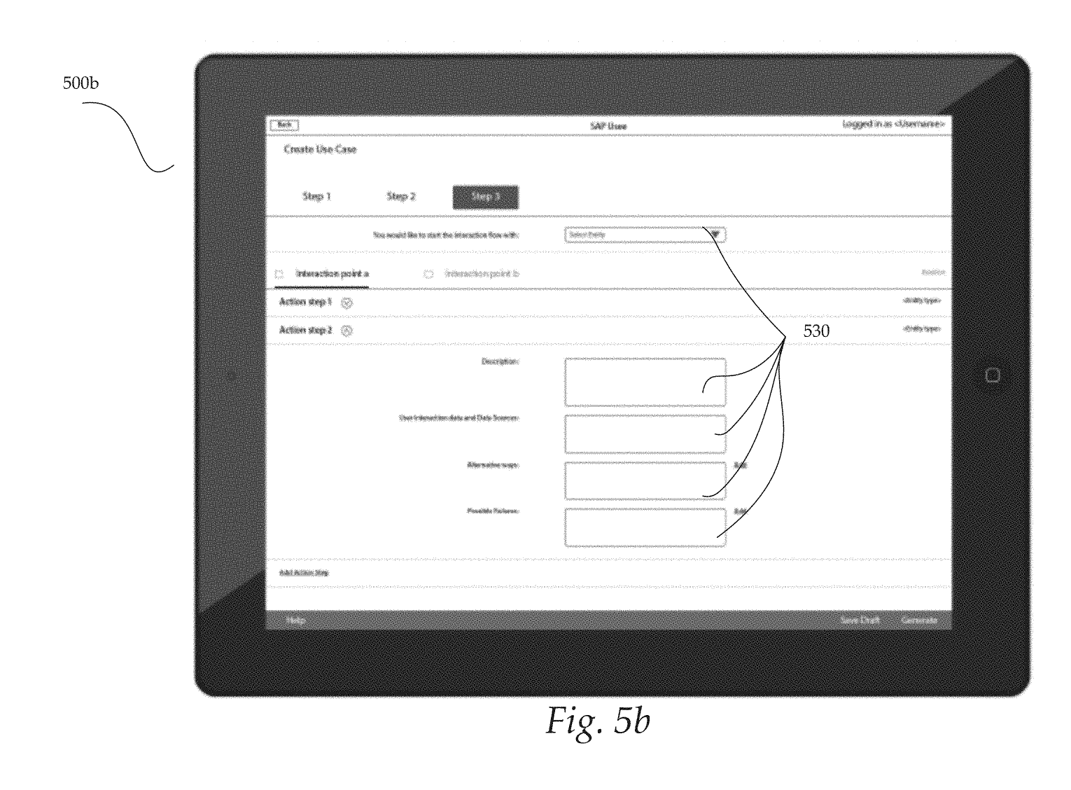

FIG. 5a illustrates another exemplary UI of the wizard-based use case creation guidance. For example, a UI 500a with the second step of the wizard-based use case creation guidance is shown. Fields 520 are displayed to prompt user input for information of entities or personas of the use case to be created. For example, information of the entities include first and second users in the use case, goal of the first or second user, pre-conditions and trigger. The first and second users, for example, are the primary and secondary users in the use case. As the user input is provided, the use case and persona handler unit dynamically performs validation of user input. The text strings of the user input may be parsed and analyzed using the validation rules. In this case, the use case and persona handler unit determines a syntactic validation of the goal input by the user. The use case and persona handler unit performs the syntactic validation and returns a validation message that indicates a successful or unsuccessful validation. For example, in the case of an unsuccessful validation, the validation message may be a recommendation of an alternative key word that more accurately defines an attribute of the use case.

FIG. 5b illustrates another exemplary UI of the wizard-based use case creation guidance. For example, a UI 500b with the third step of the wizard-based use case creation guidance is shown. Fields 530 are displayed to prompt user input for information regarding interactions between entities in the use case such as entity with which the primary or secondary user interacts with to achieve a goal, actions steps between the entities, description of the action steps, user interaction data and data source, alternative ways or actions, and possible failures. As the user input is provided, the use case and persona handler unit dynamically performs validation of the user input.

In some implementations, the use case and persona analyzer unit performs analysis of the user input with existing use cases and personas in the database module to determine existing use cases and/or personas with similar attributes to that provided in the user input. For example, the analysis is performed in real-time as the user inputs the data and/or selects a “Generate” button. The use case and persona analyzer unit, in one implementation, cross-analyzes, compares and evaluates the user input with existing use cases and personas data in the database module. For example, the use case and persona analyzer unit determines similarities such as user roles or goals provided in the user input. For example, the use case and persona analyzer unit associates the user input (e.g., where a user role is detailed such as tasks, needs, and requirements) with the elements of a persona in the database.

In the case of potential similarity, the use case and persona analyzer unit dynamically prompts the user to review the existing use cases and the related information. In one implementation, the use case and persona analyzer unit determines a probability of the similarity and returns a probability score of the similarity. For example, existing use cases with a similarity score that exceeds a predetermined threshold similarity score is determined and displayed to the user. This provides an ease of use and quick comparison with other use cases, and allows the user to perform quick adjustments to use case being created irrespective of the various contexts of the other use cases. For example, the user may dynamically configure the use case definition upon viewing information of one or more existing use cases or personas with similar attributes. The user, for example, may define or redefine entities, shuffle action steps and interaction flow.

In some implementations, the use case and persona analyzer unit facilitates identification of overlaps (e.g., same use case different roles or applications, or same role/use case but different applications). This advantageously facilitates consistent development of use cases and prevents or reduces producing duplicate or similar use cases for a similar or the same role or user activity in creating the use cases. Additionally, providing immediate feedback through recommendations or suggestions and validations of the inserted text based on rules facilitates in providing a quality content of the developed use case. The use case and persona analyzer unit may perform the analysis using various statistical models and comparison algorithms.

The result of the similarity analysis is provided to the user. A use case and persona analysis report may be further generated and stored in the database module for review. In other implementations, the use case and persona analyzer unit provides users with real-time feedback about the strength and the quality of their use case based on analysis, for example, of the interaction steps and flow.

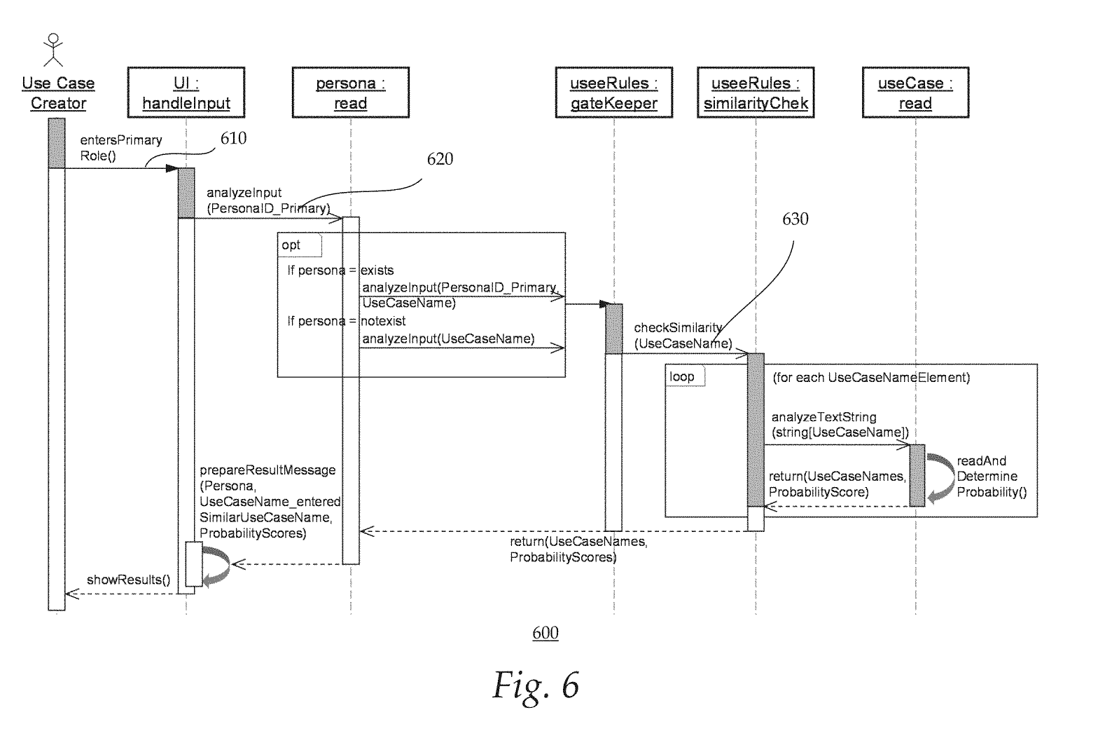

FIG. 6 shows an exemplary sequence diagram 600 of an analysis performed by the use case and persona analyzer unit. At 610, the UI layer receives a user input such as the role of a primary user in the use case to be developed from a UI of a client device. The use case and persona analysis unit parses and analyzes the user input as it is provided. In one implementation, the user input attribute with respect to the entity or persona is first analyzed. For example, in the case where the role of the primary user is provided, at 620, the use case and persona analyzer unit determines whether a similar persona exists in the database module. In the case where a similar persona is identified, a message may be displayed to inform the user (including a probability score) so he or she may use that persona. If no similar persona exists, a message may be presented, indicating that the persona is not recognized or existing and that the user may create the persona first.

At 630, the use case and persona analyzer unit then determines similarity of a use case name in the user input with use case name of each existing use case in the database module. For example, the text strings of each element in the use case name provided in the user input is compared with each element in the use case name of existing use cases. A probability score of the similarity may be generated. The use case and persona analyzer unit returns the result of the analysis to the user. For example, the UI displays a result message which contains information such as the analyzed persona, use case name provided in the user input, similar use case names and probability score of the similarity.

Based on information of similar use cases returned by the system, the user may define or re-define the entities, shuffle the action steps and the interaction flow, for example, until an acceptable qualitative version of a use case is developed. For example, users may modify the use case definition based on results of analysis performed by the use case and persona analyzer unit. The user may generate the creation of the use case when he or she is satisfied with the definition. The created use case is then stored in the database.

In one implementation, the use case and persona handler unit documents the created use case in the database module and provides a visualization of the use case using a use case diagram. The use case diagram, in one implementation, is a hybrid use case diagram. The hybrid use case diagram is a graphical and textual representation of a use case. For example, the hybrid use case diagram includes both diagrammatic representations as well as textual representation of information of a use case.

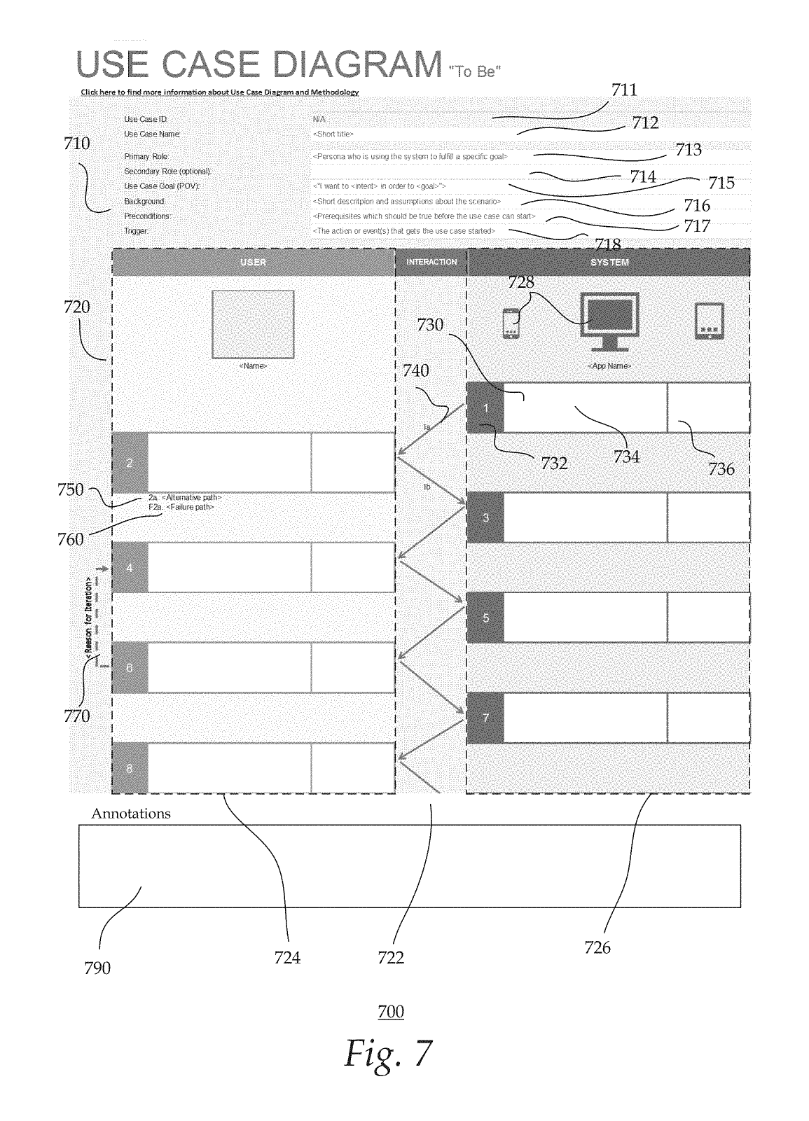

The UI layer presents a visualization of the use cases in the system including the created use case using the hybrid use case diagram. FIG. 7 illustrates an exemplary hybrid use case diagram 700 which is used to visualize a use case. In one implementation, the hybrid use case diagram includes a first portion and a second portion. The first portion may be static portions 710 and 790 while the second portion may be a dynamic portion 720. For example, the static portion of the use case diagram displays non-interaction information of the use case while the dynamic portion displays interaction information of the use case.

As illustrated, the static portion 710 includes information of a use case such as identifier of the use case 711, use case name 712, first or primary user role 713, secondary user role 714, use case goal or point of view (POV) 715, background information 716, preconditions 717 and trigger 718. The identifier of the use case is a unique reference number and may be used for cross referencing and linking with the corresponding persona. The use case name provides a descriptive name of the use case. The first or primary user role describes a persona or role of a user who interacts with another entity (e.g., a system or application) in the use case environment to fulfill a specific goal. The secondary user role describes another persona or role of a second user who receives information from the system, but is not the primary user.

The use case goal describes a user's goal such as the primary user's needs and insights or details of the user's needs. The background includes a short description about the scenario and any assumptions to the scenario. The preconditions describe prerequisites which should be true before the use case can start. The trigger identifies the action or event(s) that gets the use case started. As for the static portion 790, it is an annotations segment, which includes notes of the use case such as clarifications, references, information that are noteworthy, need to be re-visited or to be considered in the future pertinent to the specific use case or activity steps. Providing other use case information in the static portion may also be useful.

The dynamic portion displays interaction information between the entities of the use case. The dynamic portion includes entity segments and one or more interaction segments between the entity segments. In one implementation, the dynamic portion contains entity icons 730 representing entities in the use case, interaction icons 740, alternative path notations 750, failure case notations 760, and repetition notations 770. As illustrated in the use case diagram 700, interactions 722 between a first entity 724 and a second entity 726 in the use case is displayed in the dynamic portion of the hybrid use case diagram. For example, the dynamic portion visualizes interactions between a user and a system. For example, the user is a persona defined in the primary user role or secondary user role while the system is a software application in the use case. Additionally, images of the entities 728 may be displayed.

Each entity may be grouped with its corresponding entity icons 730 in an entity segment (e.g., first entity segment 724 for the first entity, and second entity segment 726 for the second entity). For example, an entity icon may be represented as an entity box. An entity box is segmented into sub-entity icons or boxes such as a first, second and third sub-entity icons 732, 734 and 736. The first sub-entity icon 732 indicates the number of the activity in a sequence of activities describing a scenario of the use case, the second sub-entity icon 734 describes the action step that needs to be undertaken by the entity in the activity to achieve a goal, and the third sub-entity icon 736 describes the interaction data of the entity and data sources (e.g., internal or external) needed to complete the action step.

The interaction icons in an interaction segment, for example, may be displayed as interaction lines representing interactions between the entities. For example, the interaction points represent interaction or activity of two different entities. The interaction lines, for example, describe the interaction points between the entities in the sequence of activities or action steps. The interaction icons, for example, express the relationships between the user and the system. They are interception points between two action steps and show how the interactions are situated in contexts of a scenario in the use case. For example, each interaction point shows the reaction of the system on a required action from the user and vice-versa.

The interaction points may be denoted using sequence of numbers or alphabets such as Ia (Interaction a), Ib, Ic, and may formulate one or more interaction paths. It should be noted that in an interaction scenario of an entity with another (i.e., user-system), there may be more than one interaction paths to define a relationship between two action steps. For example, the notification for an event that will trigger an action step may be accessed by a Notifications area or from a tile (launching an application), employed, for example, on the Fiori Launchpad. Even though there may be two different starting points (interaction points) following two different interaction paths and different subsequent interaction points (e.g., depending on which objects the user clicks), both of them lead to the same goal or result, that may also be the next action step.

The interaction points may be used in the use case diagram for various reasons such as further analysis of signifying the path and the length of a use case, the interaction behavior of the user in a use case (e.g. which interaction path he selects frequently), comparison among the same or similar use cases belonging to different applications and/or roles, point of reference on complex and iterative (e.g., loops) use cases, isolation and in depth analysis of a particular relationship (e.g., teams can use statistical models and methods to apply a more detailed quantitative and/or qualitative analysis with respect to, for example, effectiveness and efficiency, of an interaction among two actors. A team's members can further compare or analyze (e.g., by isolating and applying an in depth analysis of a particular or key relationship of two entities) or can use them as point of reference on complex and iterative use cases. This enables users of the system to define, easily cross-analyze, compare and evaluate their use cases, thus reducing any unnecessary iterations and error handling.

The alternative path notations are alternative actions or alternative options in an activity of the use case in which the main success case can succeed. For example, an alternative path provides another option for an activity within an action step that the user can take otherwise if there is possibility of a failure case. In one implementation, the alternative paths are displayed adjacent to the entity icon of an activity to which they refer. For example, an alternative path notation may be displayed below an entity icon. The alternative path notation may be denoted by the number of the activity it corresponds to and the number of the alternative action in the activity (e.g., 2a for activity 2), followed by a description of the alternative action.

The failure case notations describe possible ways in which the main success case can fail. For example, a failure case provides an indication how an action step in an activity may lead to unsuccessful result in a scenario. In one implementation, a failure case notation may be displayed adjacent to the entity icon of an activity it refers to. For example, a failure case notation may be displayed below an entity icon. The failure case may be denoted, for example, by the letter F, the number of the corresponding activity, and the number of the failure case, followed by a description of the failure case. For example, a failure case notation may be “F3a. The suggested days are outside the period the Employee wants to go on vacation” in an exemplary use case of employee leave request.

As for the repetition notations, it describes one or more possible repetitions of a specific action steps. For example, a repetition notation indicates a possible loop between two activities. For example, a repetition notation may be represented by a dotted line connecting two or more entity boxes. As illustrated, the visualization of a use case using the hybrid use case diagram provides a balanced diagrammatic and textual representation of data. The hybrid use case diagram clearly shows the flow of all the pertinent information with respect to one activity. Additionally, the hybrid use case diagram presents a clear visual distinction between the entities such as the user and the system, and their respective activities.

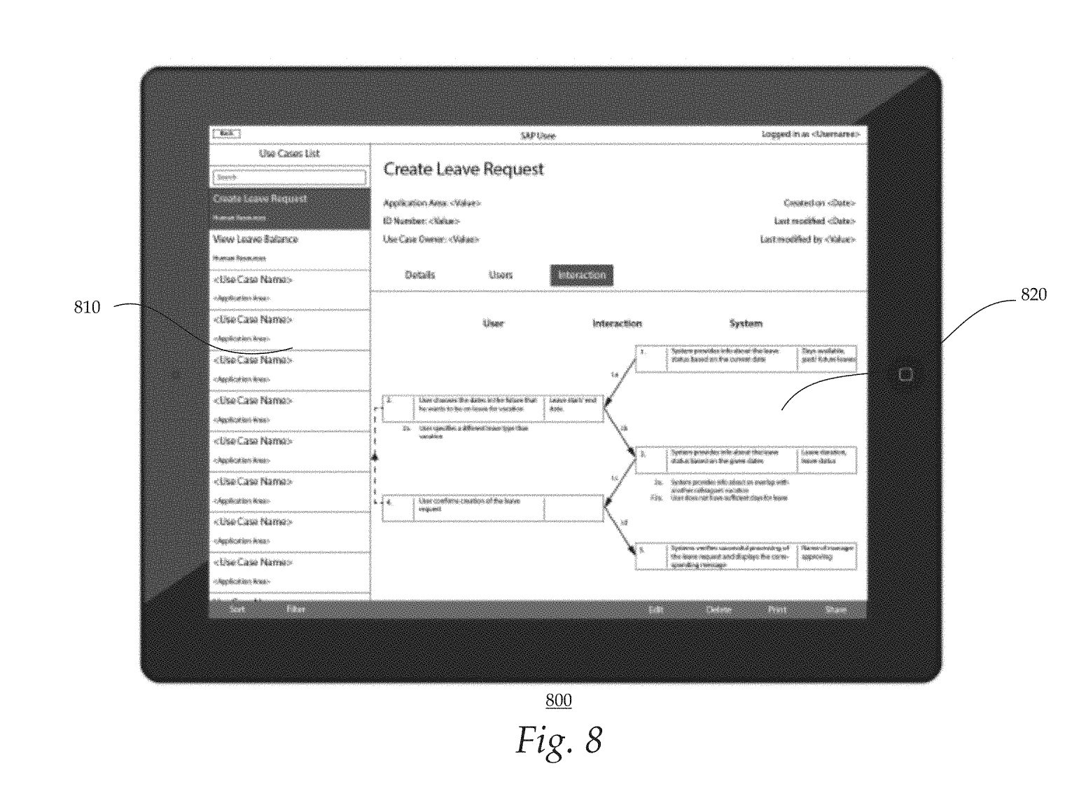

FIG. 8 shows an exemplary UI 800 displaying a list of use cases and a use case diagram of a particular use case. For example, the UI includes a recommendation of existing use cases as a result of the similarity analysis described above. The user is presented with a list of use cases 810 with attributes that is similar to the attributes provided in the user input. A use case from the list of use cases may be displayed using the hybrid use case diagram 820.

As described, the use cases may be published in a collaboration platform or network 160. For example, the created use case is published on the collaboration platform to discuss issues related to created use case and persona by users, such as other project teams. Additionally, the use case rules and algorithms employed in creating the use case may be discussed and modified in the collaboration platform. The results of the discussion may be downloaded back into the use case development application.

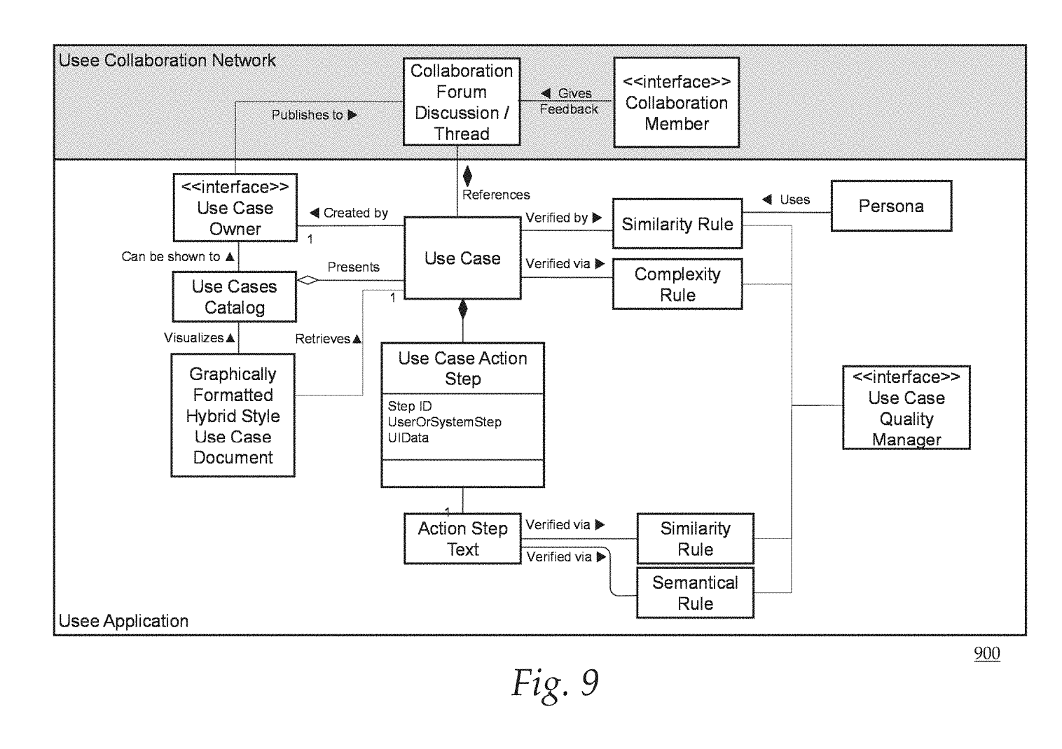

FIG. 9 illustrates an exemplary class diagram 900 of the use case development application which interfaces with the collaboration network. The use case development application publishes the developed use case in the collaboration platform. The user is presented with an option (e.g., a button in the UI) when accessing the use case development application to publish the use case to the collaboration platform. In response to the user selection to publish a use case, the use case development application triggers a call to the collaboration platform and sends the use case data with a system call. For example, the use case data structure as described is used to push the use case to the platform. In one implementation, the user may modify the details of the use case in the use case development application based on discussion in the collaboration platform. Additionally, the user may configure the settings of the use cases published in the collaboration platform such as users who may be able to view the published use cases.

The use case development application and collaboration platform communicates with collaboration-and-feedback site for obtaining feedback regarding the use cases developed in the use case development application. For example, the use cases and personas in the database module is uploaded to the collaboration-and-feedback site to run usability validation tests with other users. The collaboration-and-feedback site may be accessed by other users such as project teams using the developed use cases, end users or customers, use case and persona testers, and other interested parties of the use case. Providing an interface between the use case development application collaboration platform and collaboration-and-feedback site advantageously facilitates collaboration and integration in creating and developing use cases. All related stakeholders of a project (including customers who may be purchasing the product for which the use is built) may actively participate and have the same understanding in the development process irrespective of their different backgrounds. Such feedback or results may be downloaded to the use case development application.

As described, the use case development application may be integrated into the software design and development framework, as an add-on or plug-in to an existing application, or as a separate stand-alone application. The source code of the system may be compiled to create an executable code. The codes, for example, may be stored in a storage medium, such as one or more storage disks. Other types of storage media may also be useful. The framework increases speed in addition to providing flexibility in the design and development process, while reducing unnecessary design and development iterations.

Although the one or more above-described implementations have been described in language specific to structural features and/or methodological steps, it is to be understood that other implementations may be practiced without the specific features or steps described. Rather, the specific features and steps are disclosed as preferred forms of one or more implementations. With respect to the use of substantially any plural and/or singular terms herein, those having ordinary skill in the art can translate from the plural to the singular and/or from the singular to the plural as is appropriate to the context and/or application.

1. A computer-implemented method of a software design and development process for a user experience user research-led design (UR-Led Design) end-to-end product as a service (PaaS) definition process, comprising:
providing UR-Led Design service tools comprising ad-hoc consultation service, training service, and support service;
receiving research materials from a user in a user research stage of the software design and development process, wherein receiving the research materials includes
receiving, from a user in a user interface of a user device, user input for creating a use case, wherein the user input includes attributes of the use case,
dynamically analyzing the attributes of the use case being created as the user input is received,
displaying a validation message on the user interface, and
creating the use case and storing the created use case in a database; and
performing a readiness check based on the received research materials to determine if the user is ready to enter a design stage of the software design and development process.

2. The method of claim 1 further comprising visualizing the created use case using a hybrid use case diagram comprising diagrammatic and textual representations of the attribute of the use case.

3. The method of claim 1 wherein analyzing the attributes of the use case being created as the user input is received includes validation of the user input, wherein the validation comprises semantic and syntactic analysis of the user input based on use case rules and semantic and syntactic algorithms stored in the database.

4. The method of claim 1 wherein the validation message comprises a recommendation of one or more alternative key words in response to the user input.

5. The method of claim 4 wherein the validation message further comprises an indication of a successful validation.

6. The method of claim 1 further comprising posting the created use case in a collaboration network which is accessible by multiple other users.

7. The method of claim 1 further comprising:
determining similarities of attributes of the use case in the user input with information of existing use cases in the database; and
generating, based on the similarities, a list of use cases comprising one or more existing use cases and related information;
displaying the list of use cases to the user on a user interface of the user device; and
creating by the user an interaction between entities in the use case based on the displayed list of use cases.

8. The method of claim 7 wherein determining similarities of the user input with the existing use case and persona information comprises:
analyzing a text string in the user input with the content of the existing use case and persona information and determining the probability score of the similarity; and
displaying one or more existing use cases which exceed a similarity threshold.

9. The method of claim 7 further comprising determining similarities based on user role or user activity of the existing use cases.

10. The method of claim 1 further comprising performing validation of user interaction in the software design and development process to develop the use case.

11. A non-transitory computer readable medium embodying a program of instructions executable by machine to perform steps comprising:
receiving research materials from a user in a user research stage of a user experience user research-led design (UR-Led Design) end-to-end product as a service (PaaS) definition process, wherein receiving the research materials includes
receiving, from a user in a user interface of a user device, user input for creating a use case, wherein the user input includes attributes of the use case,
dynamically analyzing the attributes of the use case being created as the user input is received,
displaying validation messages on the user interface, and
creating the use case and storing the created use case in a database; and
visualizing the created use case using a hybrid use case diagram comprising diagrammatic and textual representations of the attribute of the use case.

12. The non-transitory computer readable medium of claim 11 further comprising performing a readiness check based on the received research materials to determine if the user is ready to enter a design stage of the UR-Led Design definition process.

13. The non-transitory computer readable medium of claim 11 wherein analyzing the attributes of the use case being created as the user input is received includes validation of the user input, wherein the validation comprises semantic and syntactic analysis of the user input based on use case rules and semantic and syntactic algorithms stored in the database.

14. The non-transitory computer readable medium of claim 11 further comprising posting the created use case in a collaboration network which is accessible by multiple other users.

15. The non-transitory computer readable medium of claim 14 further comprising publishing the created use case in a collaboration-and-feedback site to obtain feedback of the created use case.

16. The non-transitory computer readable medium of claim 11 further comprising:
determining similarities of attributes of the use case in the user input with information of existing use cases in the database; and
generating, based on the similarities, a list of use cases comprising one or more existing use cases and related information;
displaying the list of use cases to the user on the user interface of the user device; and
creating by the user an interaction between entities in the use case based on the displayed list of use cases.

17. A software design and development system for user research-led design framework, comprising:
a non-transitory memory device for storing computer-readable program code; and
a processor in communication with the memory device, the processor being operative with the computer-readable program code to
receive research materials from a user in a user research stage of the user research-led design framework, wherein receiving the research materials includes
receiving, from a user in a user interface of a user device, user input for creating a use case, wherein the user input includes attributes of the use case,
dynamically analyzing the attributes of the use case being created as the user input is received,
displaying validation messages on the user interface, and
creating the use case and storing the created use case in a database.

18. The system of claim 17 further comprising visualizing the created use case using a hybrid use case diagram comprising diagrammatic and textual representations of the attribute of the use case.

19. The system of claim 17 wherein the processor is operative with the computer-readable program code to perform a readiness check based on the received research materials to determine if the user is ready to enter a design stage of the software design and development process.

20. The system of claim 17 wherein analyzing the attributes of the use case being created as the user input is received includes validation of the user input, wherein the validation comprises semantic and syntactic analysis of the user input based on use case rules and semantic and syntactic algorithms stored in the database.
